(19) United States
(12) Patent Application Publication
(10) Pub. No.: US 2023/0334532 A1
(43) Pub. Date: Oct. 19, 2023

(54) DATA PROCESSING APPARATUS AND CONTROL METHOD FOR DATA PROCESSING APPARATUS

(71) Applicant: Toshiba Tec Kabushiki Kaisha, Tokyo (JP)

(72) Inventors: Shigeki NIMIYA, Yokohama Kanagawa (JP); Yoshitaka SAKAMOTO, Soka Saitama (JP); Nobuharu TOZAWA, Tagata Shizuoka (JP); Hajime TAKEI, Nishitokyo Tokyo (JP)

(21) Appl. No.: 18/183,496

(22) Filed: Mar. 14, 2023

(30) Foreign Application Priority Data
Apr. 15, 2022 (JP) 2022-067434

(51) Int. Cl. G06Q 30/0241; G06Q 30/0242; G06Q 30/0251

(52) U.S. Cl. CPC G06Q 30/0276; G06Q 30/0244; G06Q 30/0255

(57) ABSTRACT

According to an embodiment, a data processing apparatus generalizes an element described in advertising campaign information and derives a first target model representing a recipient image. The data processing apparatus generates, on the basis of an attribute and an action history of a recipient collected from the recipient, recipient information indicating a characteristic of each attribute of the recipient and derives, for each attribute, a second target model representing a recipient image. Further, the data processing apparatus determines a target model who is a target of the advertising campaign.

### CROSS-REFERENCE TO RELATED APPLICATIONS

This application is based upon and claims the benefit of priority from the prior Japanese Patent Application No. 2022-067434, filed on Apr. 15, 2022, the entire contents of which are incorporated herein by reference.

### FIELD

An embodiment to be described here generally relates to a data processing apparatus and a control method for a data processing apparatus.

### BACKGROUND

A supplier such as a manufacturer, an advertising company, and a retile store plans and conducts various advertising campaigns to perform sales promotions of products or the like. Further, in the past, a technology for analyzing detail data of a customer in an alliance company and supplying an advertising campaign created from the analysis result to the customer has been proposed.

Incidentally, the mainstream of an advertising campaign currently conducted is a form in which the advertising campaign is conducted for a recipient who is a target in accordance with a scenario planned by a supplier. For example, in the past, an advertising campaign to be developed in a store has been planned in accordance with a scenario in which a customer using the store is a recipient.

However, in recent years, a recipient image has been diversified due to the spread of SNS or the like. For this reason, in existing methods, there is a possibility that a recipient image assumed by a supplier and an actual recipient image are misaligned, and there is a room for further improvement.

### BRIEF DESCRIPTION OF THE DRAWINGS

FIG. 1 is a diagram showing an example of an advertising campaign support system according to an embodiment;

FIG. 2 is a block diagram showing an example of a hardware configuration of an advertising campaign support server according to the embodiment;

FIG. 3 is a block diagram showing an example of a functional configuration of the advertising campaign support server according to the embodiment;

FIG. 4 is a diagram showing an example of a configuration of an analysis unit according to the embodiment;

FIG. 5 is a diagram for describing an operation of the advertising campaign support server according to the embodiment;

FIG. 6 is a flowchart showing an example of processing executed by the advertising campaign support server according to the embodiment;

FIG. 7 is a diagram showing an example of a functional configuration of a data processing server according to a modification 1 of the embodiment; and

FIG. 8 is a diagram showing an example of a configuration of an analysis unit according to the modification 1 of the embodiment.

### DETAILED DESCRIPTION

According to an embodiment, a data processing apparatus assists in planning an advertising campaign corresponding to a supplier of an advertising campaign and a recipient of an advertising campaign. The data processing apparatus includes: a communication device; a storage device; and a processor. The communication device communicates with a supplier apparatus to be operated by the supplier and a recipient apparatus to be operated by the recipient. The storage device stores advertising campaign information in which plan content of the advertising campaign is described and information regarding an attribute and an action history of the recipient. The processor is configured to acquire the advertising campaign information from the supplier apparatus via the communication device and store the acquired advertising campaign information in the storage device. The processor is further configured to analyze the stored advertising campaign information and generalize an element described in the advertising campaign information. The processor is further configured to acquire the information regarding an attribute and an action history of the recipient from the recipient apparatus via the communication device and store the acquired information in the storage device. The processor is further configured to generate, on the basis of the stored information regarding an attribute and an action history of the recipient, recipient information indicating a characteristic for each attribute of the recipient. The processor is further configured to derive a first target model representing a recipient image on the basis of the generalized element. The processor is further configured to derive, for each attribute, a second target model representing a recipient image on the basis of the recipient information. Further, the processor is further configured to determine, on the basis of the first target model and the second target model, a target model who is a target of the advertising campaign.

Hereinafter, an embodiment will be described in detail with reference to the drawings. The same reference symbols in the drawings will denote the same or similar portions. Note that the embodiment is not limited by the following description.

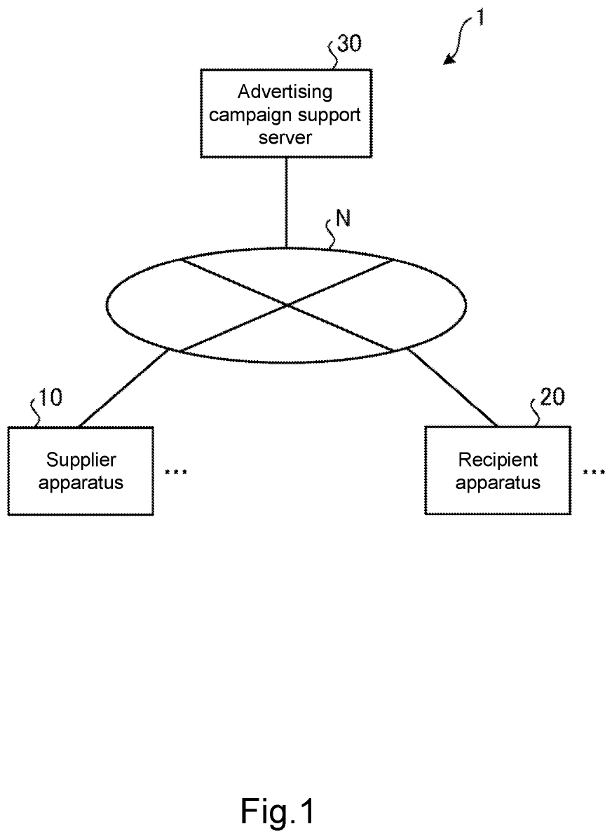

FIG. 1 is a diagram showing an example of a configuration of an advertising campaign support system according to an embodiment. As shown in FIG. 1, an advertising campaign support system 1 includes a supplier apparatus 10, a recipient apparatus 20, and an advertising campaign support server 30. The supplier apparatus 10 and the recipient apparatus 20 are connected via a network N such as the Internet so as to be communicable with the advertising campaign support server 30. Note that the number of the supplier apparatuses 10 and the number of the recipient apparatuses 20 to be connected to the network N are not particularly limited.

The supplier apparatus 10 is an information processing apparatus to be operated by a supplier that plans an advertising campaign. Examples of the supplier includes a manufacturer that produces and sells products, an advertising agency that produces advertisements and the like, and a retile store. The supplier apparatus 10 transmits, in accordance with an instruction from a supplier, advertising campaign information in which plan content such as sales promotion is described to the advertising campaign support server 30.

The advertising campaign information includes, for example, four elements of “target”, “time”, “worth”, and “notification”. The “target” is an element for specifying a recipient who is a supply target of an advertising campaign. The “time” is an element indicating a time period during which the advertising campaign is conducted, an expiration, and the like. The “worth” is an element indicating information or a service to be supplied to the recipient by the advertising campaign. The “notification” is an element indicating a method of supplying the advertising campaign. The element included in the advertising campaign information is in accordance with a scenario assumed by a supplier. Note that the advertising campaign information may include all the above-mentioned four elements or may include some of the elements. In the latter case, the advertising campaign information includes at least an element relating to the “worth”.

The recipient apparatus 20 is an information processing apparatus to be operated by a user who can be a recipient of an advertising campaign (hereinafter, referred to also as recipient). In this embodiment, as a recipient, an unspecified number of general consumers are assumed. However, the present technology is not limited thereto, and a member who has registered as a member in advance or the like may be a target of a recipient. The recipient apparatus 20 is, for example, a stationary terminal apparatus such as a personal computer (PC), a notebook PC, a tablet terminal, or a smartphone. Further, the recipient apparatus 20 may be a terminal apparatus or the like that is installed in a retile store, a restaurant, or the like and can be operated by a recipient.

The recipient apparatus 20 stores profile information in which a name, an age, a gender, a hobby/preference, or the like of a recipient who operates his/her own apparatus has been described. Further, the recipient apparatus 20 sequentially records a history of an action taken by a recipient as an action history.

Note that the method of acquiring an action history is not particularly limited, and various method can be adopted. For example, the recipient apparatus 20 may store, as an action history, a history of an operation on the apparatus itself or use content of an external service used via the apparatus itself. As an example, the recipient apparatus 20 records, as an action history, post content posted on a social networking service (SNS) via the apparats itself. Further, the recipient apparatus 20 records, as an action history, a usage history of an electronic payment service used in a retile store or the like. Further, the recipient apparatus 20 records, as an action history, a purchase history in an Internet shopping service.

Further, the recipient apparatus 20 transmits profile information and an action history to the advertising campaign support server 30. In this case, the recipient apparatus 20 may transmit profile information and an action history simultaneously or at different timings. However, identification information such as a user ID is attached to both of these pieces of data so that the profile information and the action history can be identified as those relating to the same recipient.

The advertising campaign support server 30 is an example of a data processing apparatus. The advertising campaign support server 30 analyzes data transmitted from the supplier apparatus 10 and the recipient apparatus 20 to determine a recipient to be supplied with an advertising campaign and a method of supplying the advertising campaign.

Note that although an example in which the advertising campaign support server 30 is realized by a single server apparatus will be described in this embodiment, the present technology is not limited thereto. For example, the advertising campaign support server 30 may be realized by a plurality of server apparatuses by a technology such as cloud computing.

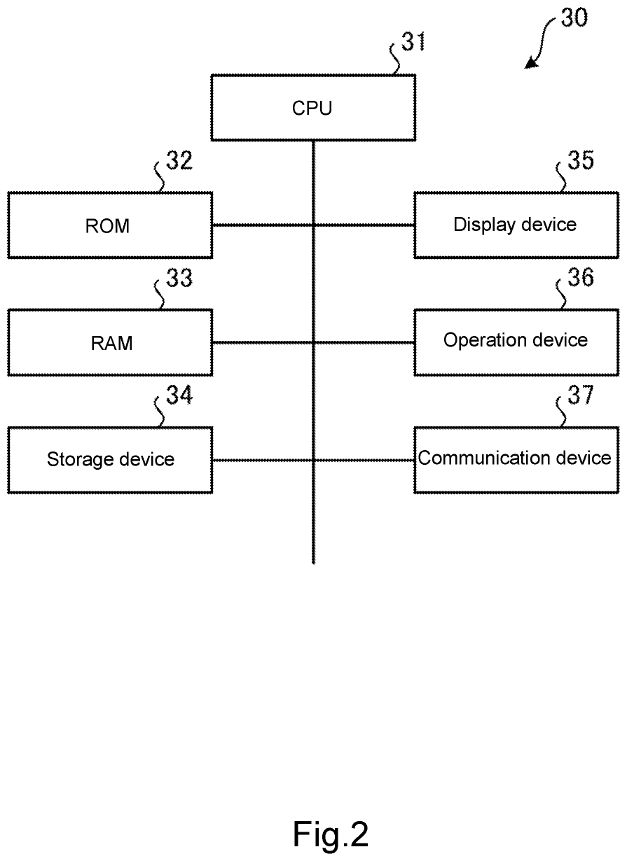

Next, the configuration of the above-mentioned advertising campaign support server 30 will be described. FIG. 2 is a diagram showing an example of a hardware configuration of the advertising campaign support server 30. As shown in FIG. 2, the advertising campaign support server 30 has a computer configuration such as a central processing unit) (CPU) 31, a read only memory (ROM) 32, and a random access memory (RAM) 33.

The CPU 31 is an example of a processor and integrally controls the respective units of the advertising campaign support server 30. The ROM 32 stores various programs. The RAM 33 is a work space for developing programs and various types of data.

Further, the advertising campaign support server 30 includes a storage device 34, a display device 35, an operation device 36, and a communication device 37.

The storage device 34 includes a storage medium such as a hard disk drive (HDD) and a flash memory, and retains the stored content even when the power source is cut off. The storage device 34 stores a program that can be executed by the CPU 31 and various types of setting information. Further, the storage device 34 functions as a storage area for storing various types of data transmitted from an external device such as the supplier apparatus 10 and the recipient apparatus 20 and a storage area for storing processing results.

The display device 35 includes a display such as a liquid crystal display (LCD). The display device 35 displays various types of information under the control of the CPU 31. The operation device 36 includes a keyboard, a pointing device, and the like. The operation device 36 outputs the content of an operation received from an operator to the CPU 31. Note that the operation device 36 may include a touch panel provided on a display screen of the display device 35.

The communication device 37 is a communication interface connectable to the network N. The communication device 37 communicates with an external device such as the supplier apparatus 10 and the recipient apparatus 20 via the network N.

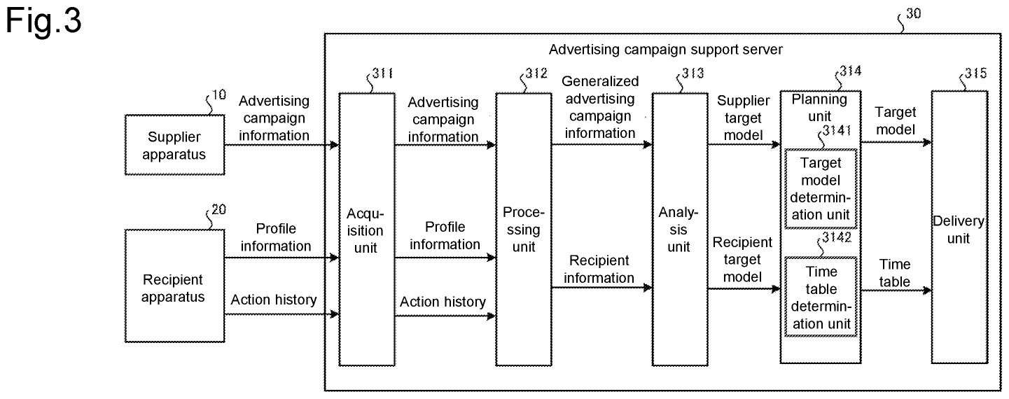

Next, a functional configuration of the advertising campaign support server 30 will be described with reference to FIG. 3. FIG. 3 is a diagram showing an example of a functional configuration of the advertising campaign support server 30.

As shown in FIG. 3, the advertising campaign support server 30 includes an acquisition unit 311, a processing unit 312, an analysis unit 313, a planning unit 314, and a delivery unit 315 as a functional configuration.

All or part of the functional configuration of the advertising campaign support server 30 may be a software configuration realized by cooperation of a processor (e.g., the CPU 31) of the advertising campaign support server 30 and a program stored in a memory (e.g., the ROM 32 or the storage device 34). Further, all or part of the functional configuration of the advertising campaign support server 30 may be a hardware configuration realized by a dedicated circuit or the like mounted on the advertising campaign support server 30.

In the following description, for example, the processor (CPU 31) executes a program stored in the ROM 32 or the storage device 34 to operate as the functions units 311 to 315. The acquisition unit 311 is an example of a first acquisition means and a second acquisition means. The acquisition unit 311 acquires (or collects) various types of data transmitted from an external device such as the supplier apparatus 10 and the recipient apparatus 20 via the communication device 37. Specifically, the acquisition unit 311 acquires advertising campaign information transmitted from each of the supplier apparatuses 10. Further, the acquisition unit 311 acquires profile information and an action history transmitted from each of the recipient apparatuses 20. The data acquired by the acquisition unit 311 is stored in the storage device 34.

The processing unit 312 is an example of a generalization means and a generation means. The processing unit 312 processes the data acquired by the acquisition unit 311. The processing unit 312 performs different types of processing on advertising campaign information, profile information, and an action history. The processing to be performed on the respective pieces of data by the processing unit 312 will be described below.

The processing unit 312 analyzes advertising campaign information in which plan content of an advertising campaign has been described and performs processing of generalizing an element described in the advertising campaign information. Specifically, the processing unit 312 analyzes an element described in the advertising campaign information at the linguistic level such as words and phrases to generalize the content meant (or intent) by the plan of the advertising campaign information.

For example, the processing unit 312 generalizes one element described in the advertising campaign information on the basis of the content meant by the element or the relationship with another element. Further, for example, the processing unit 312 may derive, from existing element described in the advertising campaign information, an element that has not been described in the advertising campaign information by generalization. As an example, the processing unit 312 may derive, from description “beer discount coupon” corresponding to the element “worth”, an element such as “20s and over”, “beer lover”, and “saver” corresponding to the element “target”. Note that the technology relating to the generalization of advertising campaign information is not particularly limited. For example, a technology or the like relating to syntactic analysis and natural language processing may be used.

The processing unit 312 generates, as generalized advertising campaign information, the result of generalizing the element described in the advertising campaign information and outputs the generated information. The processing unit 312 then stores, in the storage device 34, the generated advertising campaign information in association with the original advertising campaign information or the like.

Further, the processing unit 312 performs, on each piece of profile information, processing of anonymizing personal information contained in the profile information. Specifically, the processing unit 312 anonymizes personal information contained in the profile information and categorizes the information for each attribute such as an age and a gender. Note that the granularity of the attribute to be categorized is not particularly limited.

Further, the processing unit 312 performs, on each action history, processing of classifying the tendency and the characteristic of the action described in the action history for each attribute of the corresponding recipient.

Specifically, the processing unit 312 extracts, from each action history, the tendency and the characteristic (hereinafter, collectively referred to also as recipient characteristics) of the action for each attribute.

The processing unit 312 then stores, in the storage device 34, the anonymized and categorized attribute of a recipient and recipient characteristics of the recipient who belongs to the attribute in association with each other as recipient information. The recipient information is used for deriving a recipient target model described below.

Note that the timing of the processing to be performed on each of advertising campaign information, profile information, and an action history is not particularly limited. For example, the processing unit 312 may generate generalized advertising campaign information at the timing when the acquisition unit 311 acquired advertising campaign information. Further, for example, the processing unit 312 may store, in the storage device 34, profile information and an action history acquired by the acquisition unit 311 and perform the above-mentioned processing on the acquired profile information and action history in a predetermined time period.

The analysis unit 313 is an example of a control means. The analysis unit 313 analyzes the data processed by the processing unit 312 to derive a target model who is a target of an advertising campaign from the viewpoints of a supplier and a recipient. The target model corresponds to the above-mentioned element “target” and defines the attribute and the condition of a person image to be supplied with an advertising campaign, i.e., a recipient.

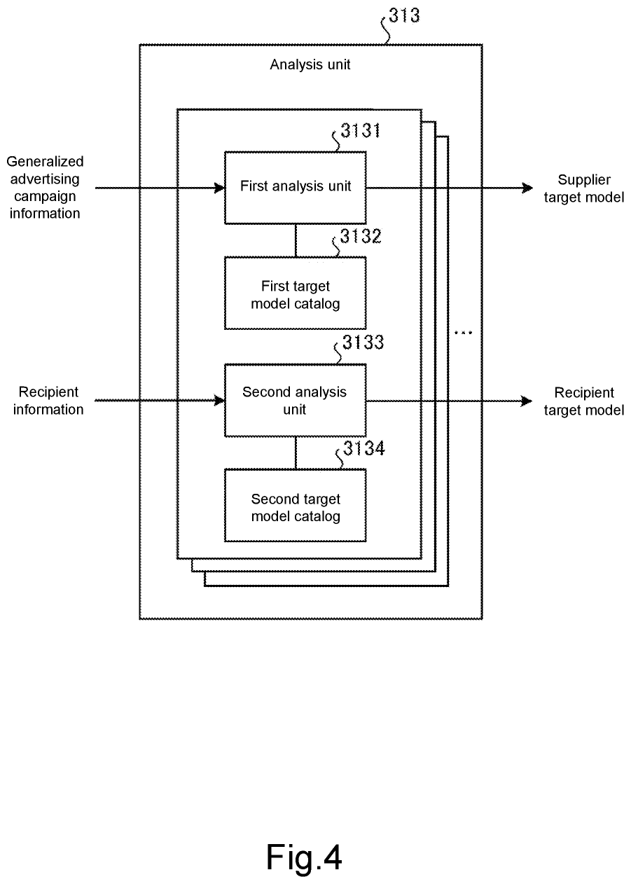

FIG. 4 is a diagram showing an example of a configuration of the analysis unit 313. As shown in FIG. 4, the analysis unit 313 includes a first analysis unit 3131, a first target model catalog 3132, a second analysis unit 3133, and a second target model catalog 3134.

The first analysis unit 3131 is an example of a first derivation means. The first analysis unit 3131 analyzes generalized advertising campaign information using the first target model catalog 3132 to derive a target model representing a recipient image from the viewpoint of a supplier (hereinafter, referred to also as a supplier target model). The supplier target model is an example of a first target model.

The first target model catalog 3132 is a trained model, dictionary data, a rule set, or the like capable of deriving, from various elements contained in the generalized advertising campaign information, a supplier target model relating to the element. The first analysis unit 3131 analyzes generalized advertising campaign information using the first target model catalog 3132 to derive a supplier target model corresponding to an element defined in the generalized advertising campaign information.

Specifically, the first analysis unit 3131 changes the method of deriving a supplier target model in accordance with whether or not there is an element relating to the “target” in generalized advertising campaign information.

The first analysis unit 3131 extends, in the case where there is an element relating to the “target” in generalized advertising campaign information, elements relating to the “target” in combination on the basis of the first target model catalog 3132 to derive one or more supplier target models.

For example, in the case where elements relating to the “target” contained in generalized advertising campaign information are “20s and over” and “alcohol lover”, the first analysis unit 3131 derives “20s and over and regularly purchase alcoholic beverages” as a supplier target model from these elements.

Further, the first analysis unit 3131 derives, in the case where an element relating to the “target” is not contained in generalized advertising campaign information, one or more supplier target models by estimation on the basis of the first target model catalog 3132 from another element contained in the generalized advertising campaign information.

The supplier target model supplied from the first analysis unit 3131 is stored in the storage device 34 in association with, for example, corresponding advertising campaign information or generalized advertising campaign information. Note that the first analysis unit 3131 may integrally include the first target model catalog 3132.

The second analysis unit 3133 is an example of a second derivation means. The second analysis unit 3133 analyzes recipient information using the second target model catalog 3134 to derive, for each attribute, a target model representing a recipient image from the viewpoint of a recipient (hereinafter, referred to also as a recipient target model). In other words, the recipient target model is a target model reflecting the actual situation of a recipient. The recipient target model is an example of a second target model.

The second target model catalog 3134 is, for example, a trained model, dictionary data, or a rule set capable of deriving, from various conditions of recipient characteristics, a recipient target model corresponding to the condition. The second analysis unit 3133 uses the second target model catalog 3134 to derive a recipient target model corresponding to the condition of recipient characteristics defined in recipient information by estimation. Specifically, the second analysis unit 3133 derives one or more recipient target models for each attribute of a recipient.

The recipient target model derived by the second analysis unit 3133 is stored in the storage device 34 in association with, for example, each attribute of recipient information. Note that the second analysis unit 3133 may integrally include the second target model catalog 3134.

With reference to FIG. 3 again, the planning unit 314 plans an advertising campaign on the basis of the analysis result of the analysis unit 313. Specifically, the planning unit 314 includes a target model determination unit 3141 and a time table determination unit 3142.

The target model determination unit 3141 is an example of a first determination means. The target model determination unit 3141 determines a target model who is a target of an advertising campaign on the basis of the supplier target model and the recipient target model derived by the analysis unit 313.

Specifically, the target model determination unit 3141 matches a supplier target model and a recipient target model. The target model determination unit 3141 determines, on the basis of the result of the matching, a recipient target model corresponding to the condition of a supplier target model as a target model. The matching method is not particularly limited, and various methods can be adopted.

For example, the condition of a supplier target model described above is a phrase defining the supplier target model described above. The target model determination unit 3141 specifies, from a recipient target model, a recipient target model who matches with part or all of the condition of a supplier target model, i.e., the phrase (including a similar phrase) defining a supplier target model). Further, for example, the target model determination unit 3141 specifies, from a recipient target model, a recipient target model having the match rate with the phrase defining a supplier target model, which is a predetermined value or more. The target model determination unit 3141 then determines the specified recipient target model as a target model.

The time table determination unit 3142 is an example of a second determination means. The time table determination unit 3142 determines a time table defining the time period in which an advertising campaign is conducted and the method of conducting the advertising campaign. The time table corresponds to the “time”, “worth”, and “notification” of the above-mentioned four elements.

Note that the method of determining a time table is not particularly limited, and various methods can be adopted. For example, the time table determination unit 3142 may determine a time table on the basis of the characteristic of a target model determined by the target model determination unit 3141. Specifically, the time table may be determined on the basis of the condition relating to the “time”, “worth”, and “notification” defining the target model. Further, for example, the time table determination unit 3142 may determine a time table on the basis of the element such as the “time”, “worth”, and “notification” included in advertising campaign information.

Note that the time table determination unit 3142 favorably performs adjustment such as shifting the time period such that the advertising campaign determined for one piece of advertising campaign information does not affect an advertising campaign of another piece of advertising campaign information and the time periods in which the advertising campaigns are conducted do not overlap.

The delivery unit 315 delivers the advertising campaign planned by the planning unit 314. Specifically, the delivery unit 315 conducts, on the basis of the time table determined by the planning unit 314, the advertising campaign for a target model determined by the planning unit 314.

For example, the delivery unit 315 notifies an external device or an external organization that performs advertising campaign activity such as delivery of an advertising campaign of the target model and the time table determined by the planning unit 314 to cause the external device or external organization to conduct the advertising campaign planned by the planning unit 314.

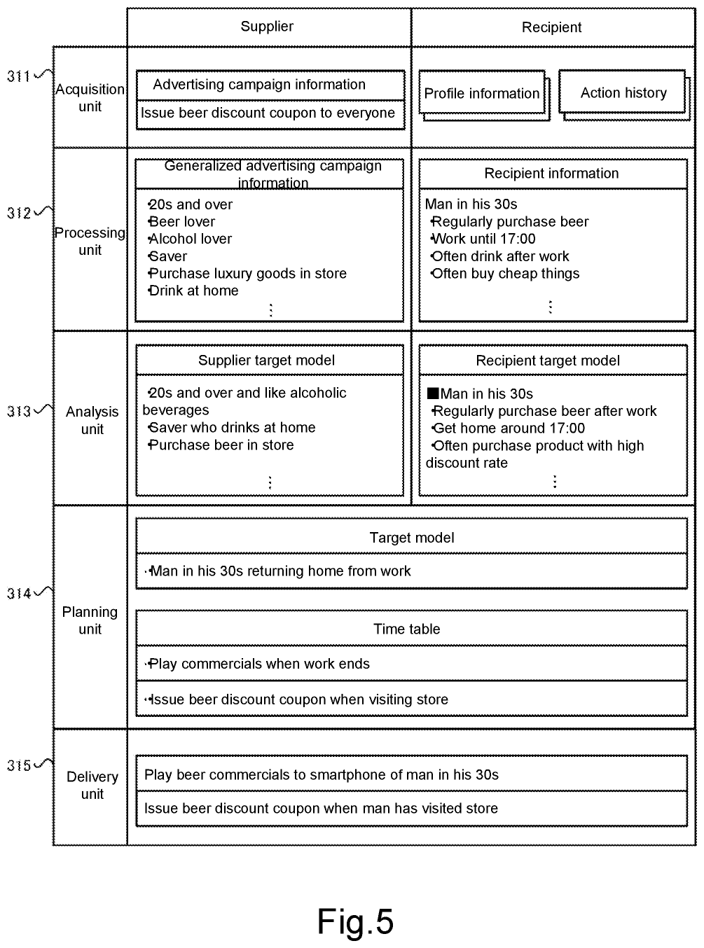

Next, an operation example of the above-mentioned acquisition unit 311, the processing unit 312, the analysis unit 313, the planning unit 314, and the delivery unit 315 will be described with reference to FIG. 5. FIG. 5 is a diagram for describing an operation of the advertising campaign support server 30. Note that in FIG. 5, The column of “supplier” shows a processing example of relating to data derived from the supplier apparatus 10. Further, the column of “recipient” shows a processing example relating to data derived from the recipient apparatus 20.

First, the acquisition unit 311 acquires advertising campaign information from the supplier apparatus 10. Further, the acquisition unit 311 acquires profile information and an action history from the recipient apparatus 20.

For example, as shown in FIG. 5, plan content of an advertising campaign such as “issue beer discount coupon to everyone” is described in the advertising campaign information. In this case, the “everyone” relates to the element “target”. Further, the “issue beer discount coupon to everyone” relates to the element “worth”. Note that since the “everyone” indicates an unspecified number, it may be regarded that the element “target” is not specified.

Subsequently, the processing unit 312 generalizes the advertising campaign information acquired by the acquisition unit 311 to generate generalized advertising campaign information. For example, the processing unit 312 generalizes the above-mentioned advertising campaign information to generate generalized advertising campaign information containing an element such as “20s and over”, “beer lover”, “alcohol lover”, “saver”, “purchase luxury goods in store”, and “drink at home”.

The “20s and over”, “beer lover”, and “alcohol lover” are elements obtained by generalizing the “everyone” and “beer” described in the advertising campaign information. Further, the “saver”, “purchase luxury goods in store”, and “drink at home” are elements obtained by generalizing the “beer” and “discount coupon” described in the advertising campaign information. Note that although the above-mentioned elements of the generalized advertising campaign information relate to the element “target”, the target of the generalization is not limited to this element.

Further, the processing unit 312 anonymizes the profile information and action history acquired by the acquisition unit 311 and performs categorization for each attribute. Specifically, the processing unit 312 categorizes the anonymized profile information for each attribute and extracts recipient characteristics from the action history of each attribute to generate recipient information in which the attribute and the recipient characteristics are associated with each other.

For example, the processing unit 312 categorizes the anonymized profile information for each age and each gender. Further, the processing unit 312 extracts, from the action history of the categorized attribute, recipient characteristics of a recipient who belongs to the attribute. In FIG. 5, for a man in his 30s, recipient characteristics such as “regularly purchase beer”, “work until 17:00”, “often drink after work”, and “often buy cheap things” are extracted.

Subsequently, the analysis unit 313 (first analysis unit 3131) derives a supplier target model from the generalized advertising campaign information using the first target model catalog 3132. In the case where an element relating to the “target” is defined in the generalized advertising campaign information, the first analysis unit 3131 derives a supplier target model on the basis of the element. For example, the first analysis unit 3131 combines the elements of the generalized advertising campaign information shown in FIG. 5 to derive “20s and over and like alcoholic beverages”, “saver who drinks at home”, “purchase beer in store”, and the like as a supplier target model.

Further, the analysis unit 313 (second analysis unit 3133) derives a recipient target model from recipient information using the second target model catalog 3134. Specifically, the analysis unit 313 derives a recipient target model for each attribute by, for example, combining recipient characteristics for each attribute contained in the recipient information. For example, as shown in FIG. 5, the analysis unit 313 derives, for a man in his 30s, “regularly purchase beer after work”, “get home around 17:00”, “often purchase product with high discount rate”, and the like as a recipient target model.

Subsequently, the planning unit 314 determines a target model and a time table. Specifically, the target model determination unit 3141 matches a supplier target model and a recipient target model to determine a target model who is a target of an advertising campaign. For example, in the case of FIG. 5, the target model determination unit 3141 matches the supplier target model and the recipient target model to determine “man in his 30s returning home from work” as a target model.

Further, the time table determination unit 3142 determines a time table on the basis of advertising campaign information, recipient characteristics relating to the target model determined by the target model determination unit 3141, and the like. For example, in FIG. 5, the time table determination unit 3142 determines “play commercials when work ends”, “issue beer discount coupon when visiting store”, and the like as a time table.

Subsequently, the delivery unit 315 delivers an advertising campaign on the basis of the target model and the time table planned by the planning unit 314. For example, the delivery unit 315 performs control for delivering beer commercials from 17:00 to the recipient apparatus 20 (e.g., a smartphone) of a user used by the man in his 30s via a video streaming site or the like. Further, for example, the delivery unit 315 performs control for issuing a beer discount coupon to the man in his 30s who has visited a store after 18:00 via a signage terminal or the like disposed in the store.

As mentioned above, the advertising campaign support server 30 matches a supplier target model and a recipient target model to determine a target model who is a target of an advertising campaign. As a result, the advertising campaign support server 30 is capable of determining, on the basis of the recipient target model derived on the basis of the actual situation of various recipients, a target model of the advertising campaign planned by a supplier. For this reason, the advertising campaign support server 30 is capable of efficiently planning an advertising campaign corresponding to a variety of recipients.

An example of processing executed by the advertising campaign support server 30 according to this embodiment will be described below.

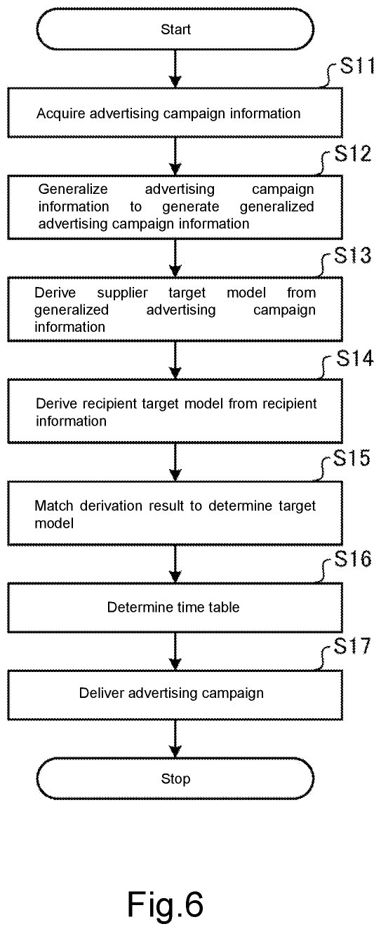

FIG. 6 is a flowchart showing an example of processing executed by the CPU 31 of the advertising campaign support server 30 as the functional units 311 to 315 described above. Note that as a premise of this processing, recipient information has been derived on the basis of the profile information and the action history acquired from each of the recipient apparatuses 20.

First, in Step S11, the acquisition unit 311 advertising campaign information from the supplier apparatus 10. Subsequently, in Step S12, the processing unit 312 generalizes the element described in the advertising campaign information acquired in Step S11 to generate generalized advertising campaign information.

Subsequently, in Step S13, the first analysis unit 3131 derives a supplier target model on the basis of the generalized advertising campaign information using the first target model catalog 3132. Further, in Step S14, the second analysis unit 3133 derives a recipient target model on the basis of the recipient information using the second target model catalog 3134.

Subsequently, in Step S15, the target model determination unit 3141 matches the supplier target model derived in Step S13 and the recipient target model derived in Step S14 to determine a target model. Further, the time table determination unit 3142 determines a time table on the basis of advertising campaign information, the characteristic of the target model determined in Step S15, and the like.

Then, in Step S17, the delivery unit 315 delivers an advertising campaign on the basis of the target model and the time table determined in Step S15 and Step S16, respectively. After the delivery, the CPU 31 ends this processing.

As described above, the advertising campaign support server 30 according to this embodiment analyzes advertising campaign information in which a plan of an advertising campaign has been described, and generalizes an element described in the advertising campaign information. The advertising campaign support server 30 derives, on the basis of the generalized element, a supplier target model representing a target image from the viewpoint of a supplier. Further, the advertising campaign support server 30 generates recipient information indicating a characteristic of the recipient for each attribute on the basis of an attribute and an action history of the recipient collected from a plurality of recipients. The advertising campaign support server 30 derives, on the basis of the generated recipient information, a recipient target model representing a target image from the viewpoint of a recipient for each attribute. The advertising campaign support server 30 determines a target model who is a target of an advertising campaign on the basis of the derived supplier target model and the derived recipient target model.

As a result, the advertising campaign support server 30 is capable of determining a target model who is a target of an advertising campaign from the supplier target model derived on the basis of the intention of the advertising campaign and the recipient target model derived on the basis of the actual situation of a variety of recipients. Therefore, the advertising campaign support server 30 is capable of assisting in planning an advertising campaign corresponding to a variety of recipients.

Further, the advertising campaign support server 30 determines, on the basis of the characteristic of the determined target model, a time period in which an advertising campaign is supplied and a method of supplying the advertising campaign. As a result, since the advertising campaign support server 30 is capable of developing an advertising campaign in a time period and method suitable of the characteristic of a target model, it is possible to assist in planning an effective advertising campaign.

Note that the above-mentioned embodiment can be appropriately modified and implemented by changing part of the configuration or function of each apparatus described above. Therefore, in the following, some modifications according to the embodiment described above will be described as other embodiments. Note that, in the following, points different from those in the above-mentioned embodiment will be mainly described, and detailed description of points common to those already described will be omitted. Further, modifications described below may be individually implemented or may be appropriately combined and implemented.

(Modification 1)

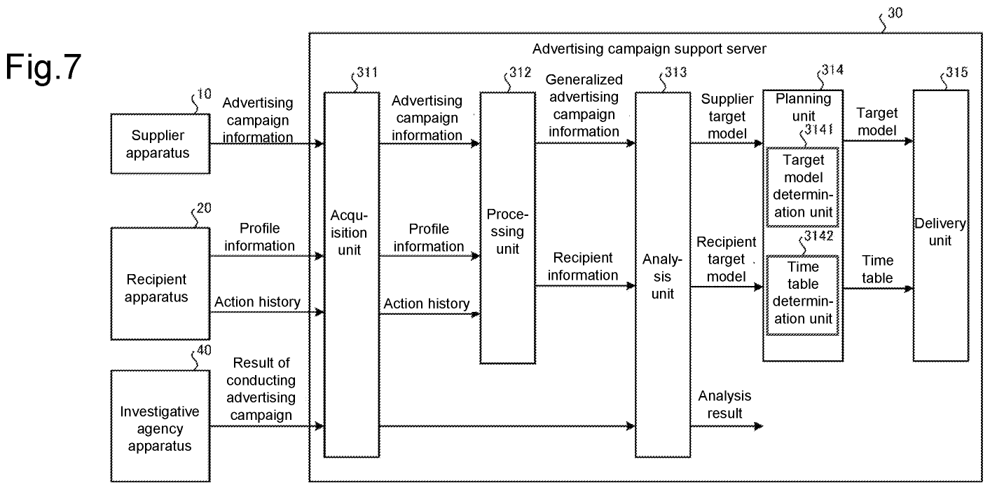

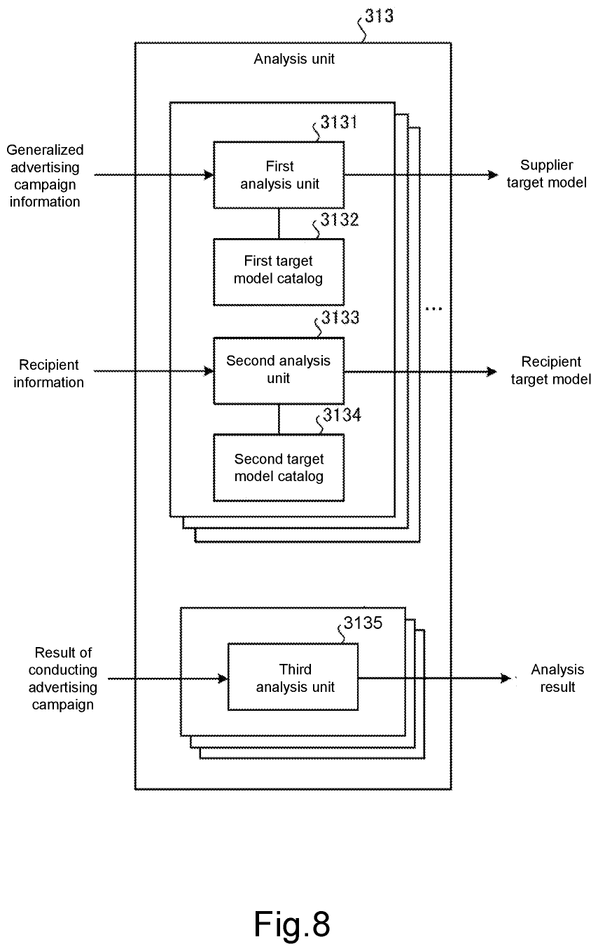

In the above-mentioned embodiment, an example in which the analysis unit 313 analyzes generalized advertising campaign information and recipient information and outputs a supplier target model and a recipient target model as an analysis result has been described. However, the analysis target of the analysis unit 313 is not limited to the above-mentioned embodiment. For example, the analysis unit 313 may analyze the result of conducting an advertising campaign. Hereinafter, a configuration of the advertising campaign support server 30 according to this modification will be described with reference to FIG. 7 and FIG. 8.

FIG. 7 is a diagram showing an example of a functional configuration of the advertising campaign support server 30 according to a modification 1. In FIG. 7, the acquisition unit 311 acquires data transmitted from the supplier apparatus 10 and the recipient apparatus 20 via the communication device 37 and acquires a result of conducting an advertising campaign transmitted from an investigative agency apparatus 40.

The investigative agency apparatus 40 is an information processing apparatus to be operated by an investigative agency that collects a result of conducting an advertising campaign. Examples of the investigative agency include a manufacturer that produces and sells products, an advertising agency that produces advertisements and the like, and a retile store.

The result of conducting an advertising campaign contains information capable of specifying the relationship between the conducted advertising campaign and sales performance of a product that is a target of sales promotion in the advertising campaign. For example, the result of conducting an advertising campaign may contain changes in sales volume of a product that is a target of sales promotion and changes in sales volume for each attribute of a purchaser of a product in a predetermined time period including a time period in which the advertising campaign is conducted. Further, the result of conducting an advertising campaign may be purchase information such as an electronic receipt issued when each user (recipient) purchased a product. In this case, the purchase information includes a store that a user has purchased a product, a purchased product, a date and time when purchase was made, and the like.

Note that the method of collecting the result of conducting an advertising campaign is not particularly limited, and a publicly known and used technology can be used.

The acquisition unit 311 outputs, upon acquiring the result of conducting an advertising campaign from the investigative agency apparatus 40, the acquired result of conducting an advertising campaign to the analysis unit 313.

In the case where the result of conducting an advertising campaign contains information capable of specifying an individual, such as a user ID, the acquisition unit 311 may output the result of conducting an advertising campaign to the processing unit 312 to cause the processing unit 312 to perform anonymization and categorization for each attribute. In this case, for example, the processing unit 312 only needs to refer to a member master or the like in which an identifier such as a user ID and profile information of a user corresponding to the identifier are associated with each other and perform anonymization of the result of conducting an advertising campaign and categorization for each attribute. The processing unit 312 then outputs, to the analysis unit 313, the processed result of conducting an advertising campaign.

The analysis unit 313 analyzes the input result of conducting an advertising campaign and outputs the analysis result. FIG. 8 is a diagram showing an example of a configuration of the analysis unit 313 according to this modification. As shown in FIG. 8, the analysis unit 313 includes a third analysis unit 3135 in addition to the configuration described in FIG. 4.

The third analysis unit 3135 analyzes the result of conducting an advertising campaign to output, as an analysis result, an index value or the like indicating the effects of the advertising campaign. Note that the analysis method of the result of conducting an advertising campaign is not particularly limited and a known marketing analysis method or the like may be used.

For example, the third analysis unit 3135 outputs, as an analysis result, a difference in purchase rate between a target model and those other than the target model of a product that is a target of sales promotion, a difference in purchase rate between an advertising campaign period and a period other than the advertising campaign period, or the like.

The analysis result of the third analysis unit 3135 may be stored in the storage device 34 or may be supplied to the supplier apparatus 10 or the like via the delivery unit 315. Further, the analysis result of the third analysis unit 3135 may be used as data for improving the derivation accuracy of the first target model catalog 3132 or the second target model catalog 3134. For example, in the case where the first target model catalog 3132 or the second target model catalog 3134 includes a trained model, the analysis result of the third analysis unit 3135 may be used as training data.

As a result, the advertising campaign support server 30 according to this modification is capable of performing a series of processes from the planning and conduct of an advertising campaign to the analysis of a conduct result. Therefore, the advertising campaign support server 30 is capable of more effectively assisting an advertising campaign planned by a supplier.

Note that the program to be executed by each apparatus according to the above-mentioned embodiment is pre-installed in a ROM, a storage unit, or the like in advance and provided. The program to be executed by each apparatus according to the above-mentioned embodiment may be recorded in a recording medium that can be read by a computer, such as a CD-ROM, a flexible disk (FD), a CD-R, and a digital versatile disk (DVD) in a file of an installable format or an executable format, and provided.

Further, the program to be executed by each apparatus according to the above-mentioned embodiment may be stored in a computer connected to a network such as the Internet, downloaded via the network, and provided. Further, the program to be executed by each apparatus according to the above-mentioned embodiment may be provided or distributed via a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data processing apparatus that assists in planning an advertising campaign corresponding to a supplier of an advertising campaign and a recipient of an advertising campaign, comprising:
a communication device that communicates with a supplier apparatus to be operated by the supplier and a recipient apparatus to be operated by the recipient;
a storage device that stores advertising campaign information in which plan content of the advertising campaign is described and information regarding an attribute and an action history of the recipient; and
a processor configured to
acquire the advertising campaign information from the supplier apparatus via the communication device and store the acquired advertising campaign information in the storage device,
analyze the stored advertising campaign information and generalize an element described in the advertising campaign information,
acquire the information regarding an attribute and an action history of the recipient from the recipient apparatus via the communication device and store the acquired information in the storage device,
generate, on a basis of the stored information regarding an attribute and an action history of the recipient, recipient information indicating a characteristic for each attribute of the recipient,
derive a first target model representing a recipient image on a basis of the generalized element,
derive, for each attribute, derive a second target model representing a recipient image on a basis of the recipient information, and
determine, on a basis of the first target model and the second target model, a target model who is a target of the advertising campaign.

2. The data processing apparatus according to claim 1,
wherein
the processor is further configured to match the first target model and the second target model, and determine, on the basis of the result of the matching, the second target model corresponding to the condition of the first target model as a target model.

3. The data processing apparatus according to claim 2, wherein
the condition of the first target model is a phrase defining the first target model, and
the processor is further configured to specify, from the second target model, the second target model who matches with part or all of the condition of the first target model, and determine the specified second target model as a target model.

4. The data processing apparatus according to claim 1, wherein
the processor is further configured to determine, on a basis of a characteristic of the determined target model, a time period in which the advertising campaign is supplied.

5. The data processing apparatus according to claim 1, wherein
the processor is further configured to determine, on a basis of a characteristic of the determined target model, a method of supplying the advertising campaign.

6. The data processing apparatus according to claim 1, wherein
the supplier apparatus includes a plurality of supplier apparatuses,
the communication device communicates with the plurality of supplier apparatuses, and
the processor is further configured to acquire the advertising campaign information from each of the plurality of supplier apparatuses via the communication device.

7. The data processing apparatus according to claim 6, wherein
the processor is further configured to generalize the advertising campaign information acquired from each of the plurality of supplier apparatus.

8. The data processing apparatus according to claim 1, wherein
the recipient apparatus includes a plurality of recipient apparatuses,
the communication device communicates with the plurality of recipient apparatuses, and
the processor is further configured to acquire the information regarding an attribute and an action history of the recipient from each of the plurality of recipient apparatuses via the communication device.

9. The data processing apparatus according to claim 8, wherein
the processor is further configured to anonymize the information regarding an attribute and an action history of the recipient acquired from each of the plurality of recipient apparatuses to generate the recipient information.

10. A control method for a data processing apparatus that assists in planning an advertising campaign corresponding to a supplier of an advertising campaign and a recipient of an advertising campaign, comprising:
acquiring the advertising campaign information from a supplier apparatus to be operated by the supplier via a communication device and storing the acquired advertising campaign information in a storage device;
analyzing the stored advertising campaign information and generalizing an element described in the advertising campaign information;
acquiring information regarding an attribute and an action history of the recipient from a recipient apparatus to be operated by the recipient via the communication device and storing the acquired information in the storage device;
generating, on a basis of the stored information regarding an attribute and an action history of the recipient, recipient information indicating a characteristic for each attribute of the recipient;
deriving a first target model representing a recipient image on a basis of the generalized element;
deriving, for each attribute, a second target model representing a recipient image on a basis of the recipient information; and
determining, on a basis of the first target model and the second target model, a target model who is a target of the advertising campaign.
